(19) United States
(12) Patent Application Publication
(10) Pub. No.: US 2015/0286710 A1
(43) Pub. Date: Oct. 8, 2015

(54) CONTEXTUALIZED SENTIMENT TEXT ANALYSIS VOCABULARY GENERATION

(71) Applicant: Adobe Systems Incorporated, San Jose, CA (US)

(72) Inventors: Walter W. Chang, San Jose, CA (US); Emre Demiralp, San Francisco, CA (US)

(73) Assignee: Adobe Systems Incorporated, San Jose, CA (US)

(21) Appl. No.: 14/244,801

(22) Filed: Apr. 3, 2014

(51) Int. Cl. G06F 17/30; G06N 7/00; G06N 99/00

(52) U.S. Cl. CPC G06F 17/30705; G06N 99/005; G06N 7/005

(57) ABSTRACT

In techniques for contextualized sentiment text analysis vocabulary generation, a contextual analysis application is implemented to receive input data derived from rated product or service reviews. Each of the domain-specific reviews across multiple categories include a rating that is associated with expressed sentiments about a subject within a rated review. The contextual analysis application determines categories of the subjects of the rated reviews, and then generates a sentiment score for a term that is an expressed sentiment in a rated review. The sentiment score is generated based in part on a context of the term as it pertains to the category and rating of the rated review. The contextual analysis application is implemented to then determine a polarity of a term-category pair based on the sentiment score, and generate a contextualized sentiment vocabulary for all of the term-category pairs of the expressed sentiments about the subjects of the rated reviews.

### BACKGROUND

Marketing analysts strive to obtain information about topics that customers are discussing and communicating, as well as the opinions or sentiments that may be expressed by the customers in communications about the topics. Companies that provide products and/or services want to know and understand how well a product or service is received, areas where customers are unhappy with the product or service, and to identify product and/or service suggestions or enhancements from customers. The exponential increase in on-line textual data and its relevance to business is making it all the more important to have automatic tools to analyze and understand people's perspectives and sentiments towards various topics, entities, and concepts. The volume of information to analyze is often quite large, such as thousands of comments per week. To manually sort out all of the positive, negative, and actionable suggestion comments from customers is labor intensive, tedious, and can be error-prone.

There are thousands of words (also referred to as terms) used in reviews, social messages, blogs, and various communications, and the sentiment polarity will vary depending on what topics or topic categories are being discussed. Conventional approaches to determine the topics that are being discussed and the related sentiments are typically based on statistical keyword models that are subject to numerous false positives and negatives due to sensitivity of the models to the domain or context of the topics. For example, an existing model may include a controlled vocabulary of positive and negative sentiment words, such as “good”, “excellent”, “bad”, and “awful”, which are invariant and not likely to be misinterpreted.

However, sentiment and emotion terms are highly contextual, such as the term “predictable”, which may connote something good about an accurate measuring device or a reliable digital stylus, but can reflect something bad about a movie review that indicates the movie was “predictable”. Additionally, existing models generally only count keywords, yet fail to take into account adjective negation, such as in the examples “the movie was not very good”, or “the food was really not bad at all.” A negative term may be used several words separated from the adjective in a sentence. The existing models may mistakenly determine that “the movie was good” without accounting for the adjective negation, “not very”, and mistakenly determine that “the food was bad” without accounting for the adjective negation, “really not”. Accordingly, the interpretation of many sentiment and emotion terms is highly contextual-based, and the existing models may assume a universal sentiment lexicon without an approach for determining the domain, aspect, and the related contextual sentiment of particular text.

### SUMMARY

This Summary introduces features and concepts of contextualized sentiment text analysis vocabulary generation, which is further described below in the Detailed Description and/or shown in the Figures. This Summary should not be considered to describe essential features of the claimed subject matter, nor used to determine or limit the scope of the claimed subject matter.

Contextualized sentiment text analysis vocabulary generation is described. In embodiments, a contextual analysis application is implemented to receive input data derived from rated reviews, such as from on-line review Web sites where users provide review comments and a rating. Each of the rated reviews include a rating that is associated with expressed sentiments about a subject of a rated review. The contextual analysis application is implemented to determine categories of the subjects of the rated reviews, and generate a sentiment score for a term that is an expressed sentiment in a rated review. The sentiment score is generated based in part on a context of the term as the term pertains to the category and the rating of the rated review. The contextual analysis application also generates sentiment scores for the term across multiple categories that are determined from the rated reviews, where the sentiment scores each indicate a degree to which the term is positive or negative for an associated category. The contextual analysis application is implemented to then determine a polarity of the term-category pairs based on the corresponding sentiment score, and generate a contextualized sentiment vocabulary for all of the term-category pairs of the expressed sentiments about the subjects of the rated reviews.

In embodiments, the contextual analysis application can apply a machine learning model that implements determining the categories, generating the sentiment scores for the term across the multiple categories, and determining the polarity of the term-category pairs based on the sentiment scores. Alternatively or in addition, the contextual analysis application can apply a term frequency inverse document frequency (TFIDF) and entropy model that implements determining the categories, generating the sentiment scores for the term across the multiple categories, and determining the polarity of the term-category pairs based on the sentiment scores. Alternatively or in addition, the contextual analysis application can apply a term classification model, such as logistic regression, that implements determining the categories, generating the sentiment scores for the term across the multiple categories, and determining the polarity of the term-category pairs based on the sentiment scores.

### BRIEF DESCRIPTION OF THE DRAWINGS

Embodiments of contextualized sentiment text analysis vocabulary generation are described with reference to the following Figures. The same numbers may be used throughout to reference like features and components that are shown in the Figures:

FIG. 1 illustrates an example of a device that implements a contextual analysis application to implement contextualized sentiment text analysis vocabulary generation in accordance with one or more embodiments.

FIG. 2 illustrates example method(s) of contextualized sentiment text analysis vocabulary generation in accordance with one or more embodiments.

FIG. 3 illustrates an example implementation of the contextual analysis application for a TFIDF and entropy model in accordance with one or more embodiments of contextualized sentiment text analysis vocabulary generation.

FIG. 4 illustrates example method(s) of contextualized sentiment text analysis vocabulary generation in accordance with one or more embodiments.

FIG. 5 illustrates an example implementation of the contextual analysis application for a word classification model in accordance with one or more embodiments of contextualized sentiment text analysis vocabulary generation.

FIG. 6 illustrates example method(s) of contextualized sentiment text analysis vocabulary generation in accordance with one or more embodiments.

FIG. 7 illustrates an example implementation of a sentiment analysis application in accordance with one or more embodiments of contextualized sentiment text analysis vocabulary generation.

FIG. 8 illustrates an example system in which embodiments of contextualized sentiment text analysis vocabulary generation can be implemented.

FIG. 9 illustrates an example system with an example device that can implement embodiments of contextualized sentiment text analysis vocabulary generation.

### DETAILED DESCRIPTION

Embodiments of contextualized sentiment text analysis vocabulary generation are described as techniques to analyze text data, such as in the form of on-line rated reviews, and generate contextualized affect and sentiment analysis vocabularies for the analysis of commercial and social communications within specific domains or industries. A contextual analysis application is implemented to analyze annotated sentiment vocabulary words, and then identify and rank all of the sentiment keywords by variance in polarity across the domains or categories of interest by computing a weighted entropy score for each term. The contextual analysis application can determine categories of on-line rated reviews, and generate a sentiment score for a term that is an expressed sentiment in a rated review. A sentiment score is generated based on a context of the term as the term pertains to a category and the rating of the rated review. The contextual analysis application also generates sentiment scores for the term across multiple categories that are determined from the rated reviews, where the sentiment scores each indicate a degree to which the term is positive or negative for an associated category. The contextual analysis application is implemented to then determine a polarity of the term-category pairs based on the corresponding sentiment scores.

In implementations, the techniques for contextualized sentiment text analysis vocabulary generation described herein provides that companies using emotion and sentiment analysis of consumer text can accurately and efficiently gather and provide actionable information to marketers or analysts across different industry domains. Further, the techniques overcome many of the accuracy problems that conventional statistical sentiment analysis models are subject to by reducing both false positives and false negatives that may occur from a low coverage sentiment vocabulary due to the use of only a general non-specific sentiment vocabulary, and by compensating for negation. The techniques for contextualized sentiment text analysis vocabulary generation also overcome conventional models by reducing sentiment polarity or score differences between different domains due to the lack of a contextualized sentiment vocabulary, such as for use of the term “predictable” in the movie review context versus the consumer electronics context for a reliable device. In situations where existing approaches attempt to manually build contextualized sentiment vocabularies, the techniques described herein also overcome the need for consultants or domain experts to gather, text mine, analyze, distill, extract, and review large amounts of domain specific document text in the process of manually creating similar sentiment vocabulary lists for each topic category.

While features and concepts of contextualized sentiment text analysis vocabulary generation can be implemented in any number of different devices, systems, networks, environments, and/or configurations, embodiments of contextualized sentiment text analysis vocabulary generation are described in the context of the following example devices, systems, and methods.

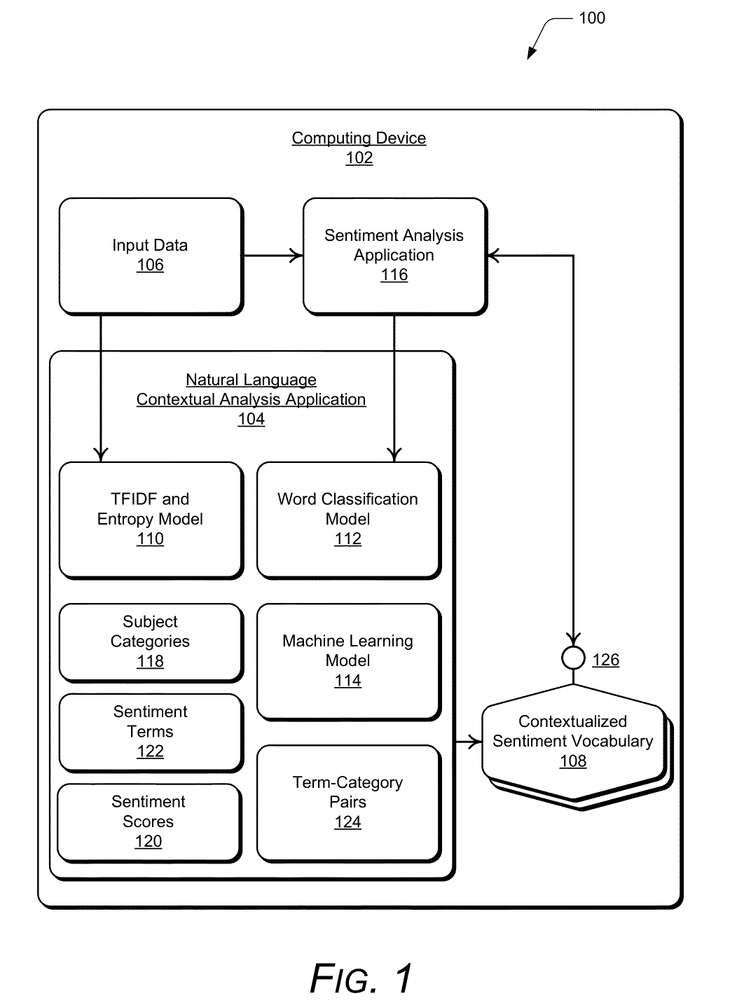

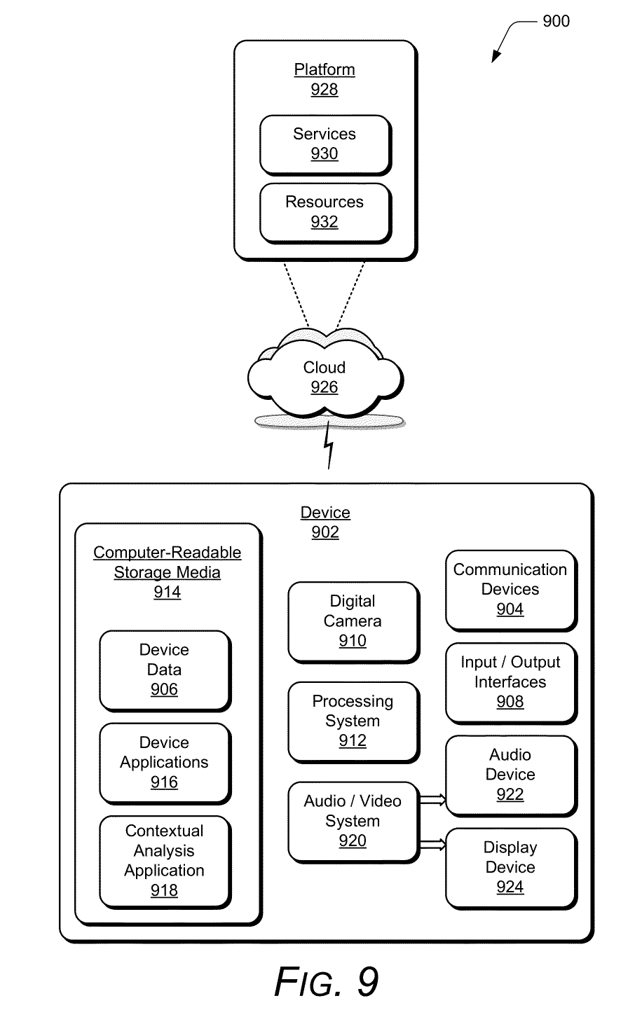

FIG. 1 illustrates an example 100 of a computing device 102 that implements a natural language contextual analysis application 104 (also referred to as the contextual analysis application) in embodiments of contextualized sentiment text analysis vocabulary generation. The contextual analysis application 104 can be implemented as a software application, such as executable software instructions (e.g., computer-executable instructions) that are executable by a processing system of the computing device 102 and stored on a computer-readable storage memory of the device. The computing device can be implemented with various components, such as a processing system and memory, and with any number and combination of differing components as further described with reference to the example device shown in FIG. 9.

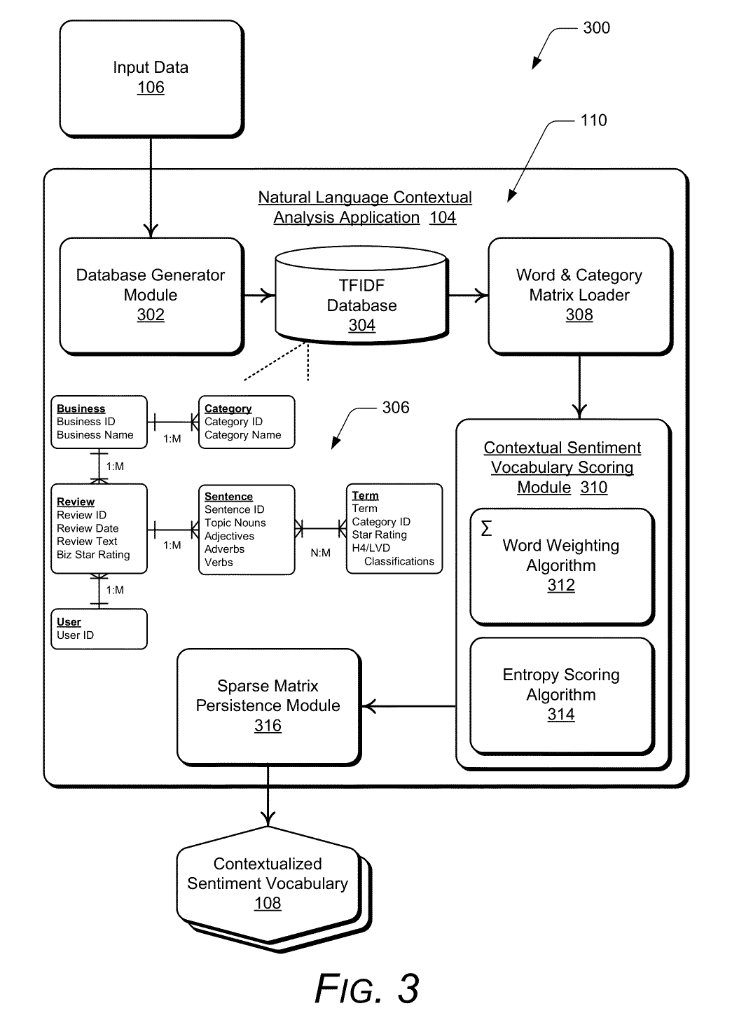

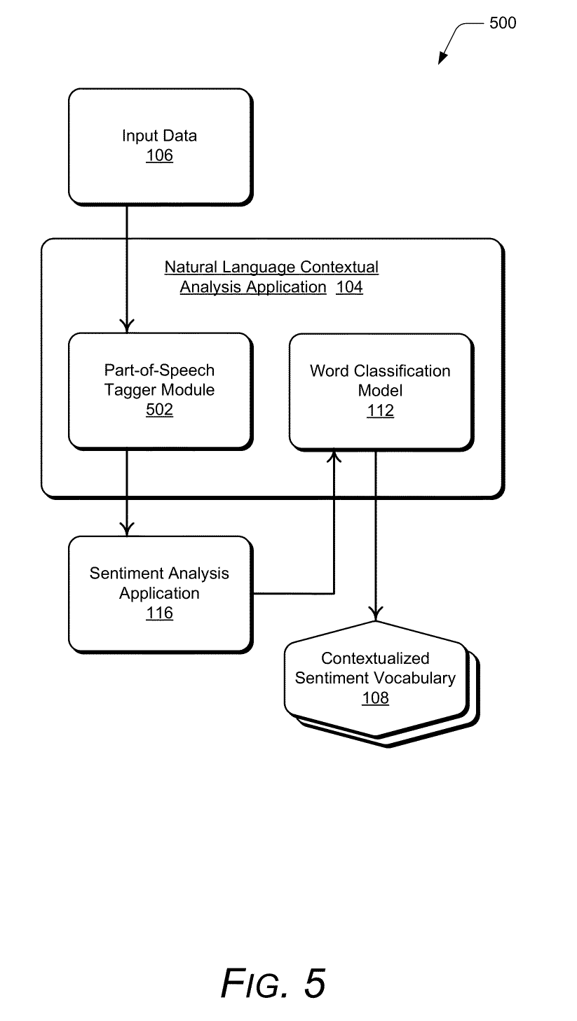

In embodiments, the contextual analysis application 104 receives input data 106, and implements one or more models to generate contextualized sentiment vocabularies 108, such as a term frequency inverse document frequency (TFIDF) and entropy model 110, a word classification model 112, and/or a machine learning model 114. The word classification model 112 may implement logistic regression, support vector machines, neural networks, Bayesian classification, and other word classification techniques. Modules and other features of the contextual analysis application 104 and implementation of the logistic regression model are further described with reference to FIG. 5. In the TFIDF and entropy model 110, the TFIDF reflects the importance of a word (also referred to as a term) in the rated reviews across the multiple categories. The TFIDF value increases proportionally to the number of times that a term appears in the rated reviews, and can be offset by the frequency that the term appears in the rated reviews. The TFIDF and entropy model 110 provides a systematic information theoretic method of evaluating the importance or significance of each contextualized sentiment term based on the amount of supporting training data evidence within the TFIDF word database, and adjusts the domain specific polarity and intensities accordingly. Modules and other features of the contextual analysis application 104 and implementation of the TFIDF and entropy model are further described with reference to FIG. 3.

The input data 106 can be received and derived from rated reviews that each include a rating associated with expressed sentiments about subjects of the rated reviews. The rated reviews can be obtained from any number of on-line review Web sites where users provide review comments and a rating that expresses an overall indication of a sentiment about the subject of a rated review. For example, a star rating for a body of text (e.g., a rated review) provides some information about the sentiment associated with the entity that the particular text is about. There are a number of Web sites where users can provide comments and indicate a degree to which they like a particular restaurant, movie, hotel, or any other entity.

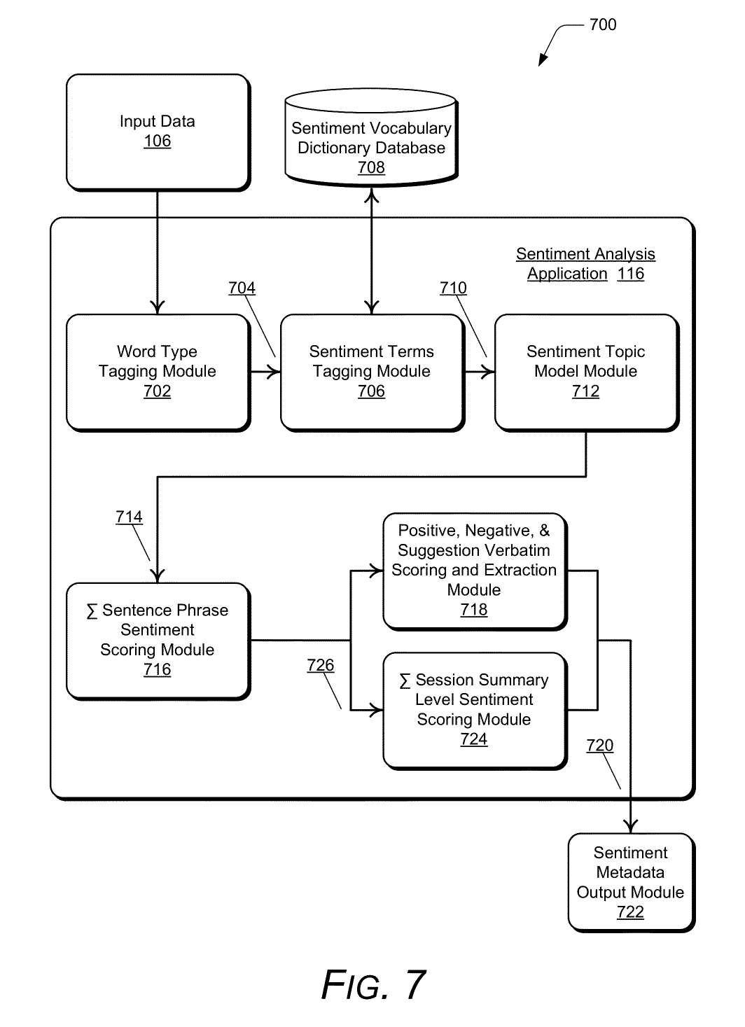

In this example 100, the computing device 102 implements a sentiment analysis application 116 (e.g., a software application) that receives the input data 106 and implements techniques for contextual sentiment text analysis of the text data that is utilized by the word classification model 112 (e.g., as implemented by the contextual analysis application 104). The sentiment analysis application can operate in a domain-specific mode by loading one or more of the contextualized sentiment vocabularies 108 that are created and organized by modules of the contextual analysis application. Modules and other features of the sentiment analysis application 116 are further described with reference to FIG. 7. Additionally, the sentiment analysis application 116 may be implemented by another computing device (or server system) from which an output of contextual sentiment text analysis is communicated to the computing device 102 as an input to the contextual analysis application 104.

The contextual analysis application 104 is implemented to identify and rank all sentiment keywords by variance in polarity across the domains or categories of interest (e.g., in the rated reviews of the input data 106) by computing a specialized weighted entropy score for each term. In implementations, the contextual analysis application 104 can determine subject categories 118 of on-line rated reviews, and generate sentiment scores 120 for the sentiment terms 122 that are expressed as sentiments in the rated reviews. A sentiment score 120 can be generated based on a context of the term 122 as it pertains to a category 118 and the rating of the rated review. The contextual analysis application also generates sentiment scores for a term across multiple categories that are determined from the rated reviews, where the sentiment scores each indicate a degree to which the term is positive or negative for an associated category. The contextual analysis application is implemented to then determine a polarity of the term-category pairs 124 based on the corresponding sentiment scores.

The contextual analysis application 104 is implemented to generate one or more affect and sentiment vocabularies in a semi-supervised or automatic mode in which sentiment polarity scores are assigned to each sentiment term in a vocabulary list depending on a specific context or domain of usage for the sentiment term. This is an automated method of learning sentiment vocabulary models for any domain, such as restaurants, hotels, airlines, etc. The contextual analysis application 104 constructs an information theoretic TFIDF word database that records the importance or frequency of usage of context terms for a specific set of domains. In implementations, the contextual analysis application can implement a machine learning workflow to generate the theoretic TFIDF word database. The contextual analysis application then utilizes the TFIDF database to compute a weighted entropy score for each sentiment term for each specific domain or context. The results can be persisted into a fast machine readable and run-time (i.e., analysis time) loadable data structure that represents the contextualized sentiment term vocabulary for use by the sentiment analysis application 116, which can increase the accuracy and coverage of the emotion and sentiment analysis.

The contextual analysis application 104 can also implement an interface by which the sentiment analysis application 116 can access the contextualized sentiment vocabulary 108 through a module API 126 (application program interface). The API 126 can be implemented as a representational state transfer (RESTful) interface, or as a direct set of method calls using a remote procedure call (RPC) interface. The sentiment analysis application 116 can provide, via the API, one or more domain or context terms to specify relevant categories (e.g., restaurant, airline travel, fashion, movie review, etc.), as well as text from the input communications to be analyzed, where the input data 106 text terms can be preprocessed through a natural language segmenter, tokenizer, part-of-speech, and phrase expression tagger to properly validate the input terms for contextualized sentiment scoring. The sentiment analysis application can efficiently retrieve sentiment polarity and intensity information from the run-time contextualized sentiment vocabulary 108 to provide a client application with term, sentence, and session (sentence collection) level emotion and sentiment scores.

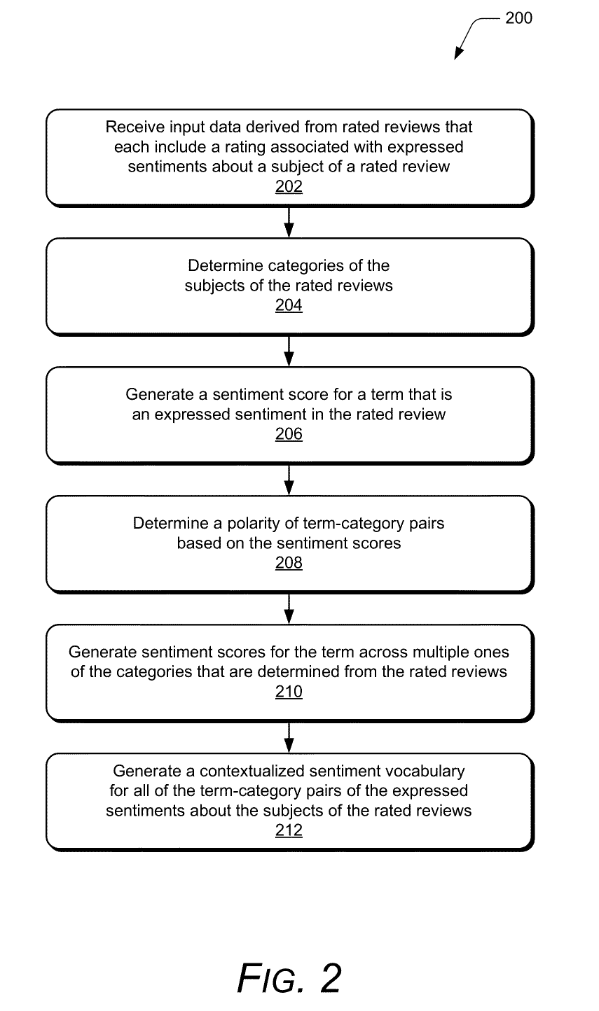

Example methods 200, 400, and 600 are described with reference to respective FIGS. 2, 4, and 6 in accordance with one or more embodiments of contextualized sentiment text analysis vocabulary generation. Generally, any of the services, components, modules, methods, and operations described herein can be implemented using software, firmware, hardware (e.g., fixed logic circuitry), manual processing, or any combination thereof. The example method may be described in the general context of executable instructions stored on a computer-readable storage memory that is local and/or remote to a computer processing system, and implementations can include software applications, programs, functions, and the like.

FIG. 2 illustrates example method(s) 200 of contextualized sentiment text analysis vocabulary generation, and is generally described with reference to a contextual analysis application implemented by a computing device. The order in which the method is described is not intended to be construed as a limitation, and any number or combination of the method operations can be combined in any order to implement a method, or an alternate method.

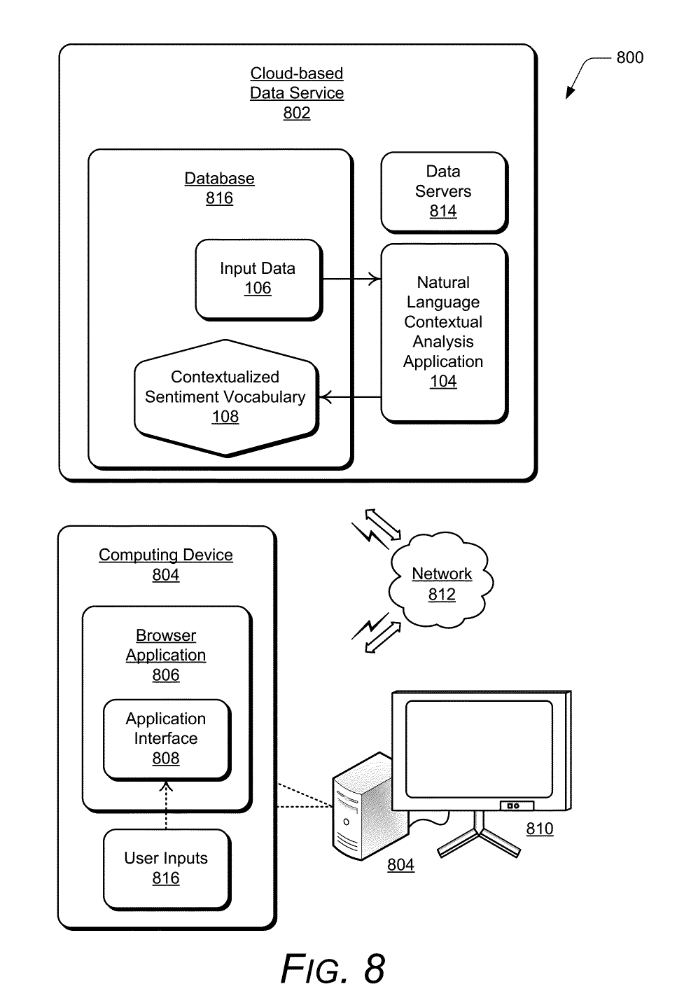

At 202, input data is received, where the input data is derived from rated reviews that each include a rating associated with expressed sentiments about a subject of a rated review. For example, the contextual analysis application 104 (FIG. 1) that is implemented by the computing device 102 (or implemented at a cloud-based data service as described with reference to FIG. 8) receives the input data 106 that is derived from rated reviews that each include a rating associated with expressed sentiments about a subject of a rated review. As described above, the rated reviews can be obtained from any number of on-line review Web sites where users provide review comments and a rating that expresses an overall indication of a sentiment about the subject of a rated review. For example, a star rating for a body of text (e.g., a rated review) provides some information about the sentiment associated with the entity that the particular text is about. There are a number of Web sites where users can provide comments and indicate a degree to which they like a particular restaurant, movie, hotel, or any other entity.

At 204, categories of the subjects of the rated reviews are determined and, at 206, a sentiment score for a term that is an expressed sentiment in the rated review is generated. For example, the contextual analysis application 104 determines the subject categories 118 of the subjects of the rated reviews and generates the sentiment scores 120 for the terms 122 that are an expressed sentiment in a rated review. The sentiment score 120 for a term is generated based at least in part on a context of the term as the term pertains to the category and the rating of the rated review. Further, at 208, a polarity of the term-category pairs is determined based on the sentiment scores. For example, the contextual analysis application 104 determines the polarity of the term-category pairs 124 based on the sentiment scores.

At 210, sentiment scores are generated for the term across multiple ones of the categories that are determined from the rated reviews. For example, the contextual analysis application 104 generates the sentiment scores 120 for a sentiment term 122 across multiple ones of the subject categories 118 that are determined from the rated reviews, and the sentiment scores each indicate a degree to which the term is positive or negative for an associated category.

At 212, a contextualized sentiment vocabulary is generated for all of the term-category pairs of the expressed sentiments about the subjects of the rated reviews. For example, the contextual analysis application 104 generates one or more of the contextualized sentiment vocabularies 108 for all of the term-category pairs 124 of the expressed sentiments about the subjects of the rated reviews.

FIG. 3 illustrates an example 300 of the contextual analysis application 104 that is implemented by the computing device 102 as described with reference to FIG. 1, and that implements embodiments of contextualized sentiment text analysis vocabulary generation in an implementation of the TFIDF and entropy model 110. The contextual analysis application 104 includes various modules that implement features of the contextual analysis application for the TFIDF and entropy model. Although shown and described as independent modules of the contextual analysis application, any one or combination of the various modules may be implemented together or independently in the contextual analysis application in embodiments of contextualized sentiment text analysis vocabulary generation.

The contextual analysis application 104 includes a database generator module 302 that is implemented to receive the input data 106, such as the rated reviews as described with reference to FIG. 1. The database generator module 302 is implemented to process the input data (e.g., the rated reviews) and generate TFIDF vocabulary databases 304 for other sentiment and non-sentiment applications. The database generator module can analyze the sentences of the reviews, extract the noun phrases, nouns, and adjectives, and then organize the input data into different categories as the TFIDF vocabulary database 304 for use by the TFIDF and entropy model 110, as well as by the term classification model 112.

In an implementation of the machine learning model 114, the database generator module 302 can generate a data model 306 of the TFIDF vocabulary database 304 with a file or relational table structure that includes a set of rows, where each sentiment term is associated with a table row in which the first column contains the sentiment term, and the next N+1 columns consist of the TFIDF scores for each term for all of the rated review documents for a particular sentiment category (context), topic, or product. The representation of the table may be sparse or non-sparse, and the non-sparse representations can include (key, value) pairs formed by the (category-name, word-TFIDF score). The data model 306 includes one or more information schemas that describe the text and category mappings of the source review or product description text, as shown in the data model.

The contextual analysis application 104 also includes a word and category matrix loader 308 (also referred to as the sparse matrix loader) that is implemented to load the TFIDF vocabulary database 304 into a sparse memory format, which is more efficient for the TFIDF entropy processing. The sparse matrix loader is implemented to read the TFIDF vocabulary database from the database generator module (or from an externally provided manual source) and creates an in-memory sparse matrix representation with keyed access to the category-name, word-TFIDF score data for each term. This achieves compact memory use and high access performance by use of a nested three-level hashmap representation that is a top-level hashmap for each sentiment term, a secondary hashmap for each active category the sentiment term applies to, and a tertiary hashmap that records the annotation score for all training document reviews for the specific category. Secondary hashmap entries can be created for each term that differs from the default sentiment polarity and intensity. In each secondary hashmap term entry, the category-name, word-TFIDF data for each review is recorded. For each secondary hashmap entry, the tertiary hashmap contains training data statistics for the annotated score distribution for all training documents for each category of the first-level term. In the tertiary hashmap level, a detailed annotation score, such as the review star counts, for each category are recorded. Computations can then be performed over the three-level nested hashmap structure.

The contextual analysis application 104 also includes a contextual sentiment vocabulary scoring module 310 that receives the in-memory sparse matrix representation from the sparse matrix loader 308, and is implemented to processes the sparse TFIDF word matrix represented by the three-level hashmap. The contextual sentiment vocabulary scoring module 310 is implemented with a word weighting algorithm 312 and an entropy scoring algorithm 314. The word weighting algorithm 312 is implemented to compute a normalized weighted TFIDF score vector based on the number of documents and terms for each category word score. This normalized TFIDF score vector can then be aggregated two different ways. The normalized TFIDF score vector is first aggregated by sentiment term to provide a measure of the polarity variance of the term across all categories. This provides a measure of the polarity distribution of the sentiment terms in the total data input across all categories of interest and identifies the invariant and variant sentiment terms. The normalized TFIDF score vector is secondly aggregated by category across all of the terms to provide the actual contextualized sentiment vocabulary list for each category, and this is input to a sparse matrix persistence module 316 that then produces the final run-time output.

The entropy scoring algorithm 314 is implemented to compute the inverse document frequency (IDF) scores by using review categories of the input data as documents. Terms that appear in numerous categories have a lower IDF (are less contextual), and terms that appear in a small number of categories have a higher IDF (are highly contextual). This measure provides a strong indication of contextual usage. The more difficult case addressed by the techniques described herein is when the same sentiment term appears in multiple contexts (e.g., “predictable” for the “movies”, “hotels”, and “digital stylus” categories) and has varying polarity. To determine the contextual polarity, a second measure is computed based on the review scores of the reviews that each term appears in for a particular category. For this purpose, an entropy measure H(X) is computed that measures the probability that a particular sentiment term is positive vs. negative given the ratings of all reviews in which the sentiment term occurs. The equations used for computing usage and contextual polarity are as follows:

$$IDF ( t , D ) = log \frac{\vert D \vert}{\vert \{ d ∈ D : t ∈ d \} \vert}$$

$$H ( X ) = - {\sum }_{i = 1}^{n} p ( {x}_{i} ) {log}_{b} p ( {x}_{i} )$$

where reviews for a category C can form a “document” d, and the variable |D| is the number of categories. To predict category star ratings for terms outside of the learned vocabulary, 1+|{dεD:tεd}| is used. A lower IDF(t,D) indicates that a term is used in numerous categories.

The contextual analysis application 104 also includes a sparse matrix persistence module 316 that is implemented to generate the contextualized sentiment vocabulary 108 for the categories. The sparse matrix persistence module generates the final output as a run-time data file that can be loaded by the sentiment analysis application 116 (as shown and described with reference to FIG. 1), or other external third-party sentiment analysis engines that may use the data file. The sparse matrix persistence module is implemented to perform a preorder traversal of the three-level hashmap structure created by the term and category matrix loader 308 and annotated by the contextual sentiment vocabulary scoring module 310. A two-level object (such as in JavaScript Object Notation) can be created such that for each term key entry at the top level, there is a secondary (key, value) map of (category-names, contextualized sentiment score). The generated output is a basic JSON data file, although XML, RDF, and other resource formats can be used. The created JSON data file can be directly loaded by the sentiment analysis application 116 and accessed through the API 126.

An example of rated reviews across multiple categories shows that invariant and non-invariant sentiment vocabulary terms are discovered across context categories. The contextual analysis application 104 determines that the term “delicious” has broad usage context, but has relatively invariant polarity context, expressing highly positive sentiment in nearly all category usages. In the example tables below, Table 1 indicates positive sentiment, Table 2 indicates neutral sentiment, and Table 3 indicates negative sentiment. Here, the term “delicious” is positive for the various categories shown in Table 1:

TABLE 1
Positive Sentiment

| delicious | | 1- | 2- | 3- | 4- | 5- |
|---|---|---|---|---|---|---|
| 4,5/1-5 | CATEGORY | Star | Star | Star | Star | Star |
| 1.00 | Resorts | 0 | 0 | 0 | 4 | 13 |
| 1.00 | Coffee Shops | 0 | 0 | 0 | 4 | 11 |
| 1.00 | Fitness & Instruction | 0 | 0 | 0 | 6 | 5 |
| 0.98 | Cambodian Restaurants | 0 | 1 | 0 | 11 | 36 |
| 0.98 | Food Stands | 0 | 0 | 2 | 29 | 62 |
| 0.98 | Street Vendors | 0 | 1 | 0 | 10 | 30 |
| 0.97 | Gelato | 1 | 0 | 1 | 30 | 41 |
| 0.97 | Polish Restaurants | 0 | 0 | 2 | 16 | 50 |
| 0.96 | Scandinavian | 0 | 0 | 2 | 14 | 35 |
| 0.96 | Afghan Restaurants | 0 | 0 | 1 | 14 | 9 |
| 0.95 | Gastropubs | 0 | 0 | 9 | 74 | 116 |
| 0.95 | Turkish Restaurants | 0 | 0 | 1 | 10 | 10 |
| 0.95 | Brazilian Restaurants | 0 | 1 | 2 | 24 | 32 |
| 0.95 | Day Spas | 0 | 3 | 0 | 16 | 39 |
| 0.94 | Beauty & Spas | 0 | 3 | 1 | 18 | 47 |
| 0.94 | British Pubs | 0 | 3 | 7 | 67 | 93 |
| 0.94 | Tea Rooms | 0 | 1 | 4 | 23 | 52 |
| 0.94 | Halal Restaurants | 0 | 0 | 4 | 25 | 35 |
| 0.93 | Ethnic Food | 1 | 1 | 6 | 49 | 65 |
| 0.93 | Tapas Bars | 0 | 0 | 2 | 14 | 13 |
| 0.93 | Ethiopian Restaurants | 0 | 1 | 5 | 49 | 25 |
| 0.92 | Meat Shops | 0 | 1 | 1 | 4 | 20 |
| 0.92 | Flowers & Gifts | 0 | 0 | 1 | 4 | 8 |
| 0.92 | Ice Cream & Frozen | 5 | 8 | 38 | 234 | 367 |
| | Yogurt | | | | | |
| 0.92 | Fruits & Veggies | 0 | 0 | 4 | 21 | 24 |
| 0.92 | Basque Restaurants | 0 | 0 | 1 | 6 | 5 |
| 0.91 | British Restaurants | 0 | 2 | 6 | 28 | 53 |
| 0.91 | Caterers | 0 | 4 | 9 | 54 | 77 |
| 0.91 | Hot Dogs | 0 | 7 | 20 | 121 | 150 |
| 0.91 | Sporting Goods | 1 | 0 | 0 | 5 | 5 |

Alternatively as shown in the example tables below, the sentiment term “loud” while also being widely used across categories, conveys different sentiment polarity depending on the context as shown in Table 2. In the context of “British Pubs”, the term “loud” is associated with positive sentiment, while in the “Golf Courses” category, the term is associated with varied negative to positive sentiment. Finally, in certain categories such as “Hotels”, “Real Estate”, and “Fashion”, the term “loud” is largely associated with negative sentiment, as shown in Table 3 below.

TABLE 2
Neutral Sentiment

| loud | | 1- | 2- | 3- | 4- | 5- |
|---|---|---|---|---|---|---|
| 4,5/1-5 | CATEGORY | Star | Star | Star | Star | Star |
| 0.85 | British Pubs | 0 | 1 | 4 | 20 | 9 |
| 0.83 | Soul Food Restaurants | 0 | 1 | 1 | 6 | 4 |
| 0.82 | Cajun/Creole Restaurants | 0 | 0 | 3 | 6 | 8 |
| 0.78 | Breweries | 2 | 9 | 20 | 67 | 45 |
| 0.77 | Art Galleries | 0 | 1 | 5 | 13 | 7 |
| 0.75 | Bowling | 2 | 1 | 1 | 10 | 2 |
| 0.73 | Gastropubs | 0 | 3 | 3 | 10 | 6 |
| 0.71 | British Restaurants | 0 | 1 | 3 | 6 | 4 |
| 0.71 | Wine Bars | 8 | 9 | 29 | 76 | 36 |
| 0.69 | Latin American Restaurants | 2 | 8 | 5 | 23 | 11 |
| 0.69 | Hawaiian Restaurants | 1 | 1 | 2 | 8 | 1 |
| 0.69 | Specialty Food | 0 | 0 | 5 | 7 | 4 |
| 0.67 | Active Live | 4 | 6 | 14 | 30 | 18 |
| 0.65 | Pubs | 2 | 27 | 39 | 91 | 35 |
| 0.65 | Cafes | 0 | 2 | 4 | 7 | 4 |
| 0.64 | Coffee & Tea | 13 | 21 | 33 | 72 | 48 |
| 0.64 | Music Venues | 9 | 8 | 28 | 49 | 30 |
| 0.64 | Public Service & | 0 | 1 | 3 | 4 | 3 |
| | Government | | | | | |
| 0.64 | Food | 24 | 63 | 100 | 200 | 126 |
| 0.63 | Mediterranean Restaurants | 8 | 20 | 13 | 45 | 26 |
| 0.63 | Lounges | 15 | 27 | 49 | 105 | 49 |
| 0.63 | Tapas/Small Plates | 2 | 3 | 4 | 9 | 6 |
| 0.63 | Thai Restaurants | 3 | 3 | 12 | 23 | 7 |
| 0.63 | Food Delivery Services | 1 | 1 | 4 | 8 | 2 |
| 0.62 | Vegetarian Restaurants | 2 | 17 | 14 | 33 | 21 |
| 0.46 | Sushi Bars | 39 | 57 | 102 | 135 | 33 |
| 0.45 | Shopping | 12 | 26 | 20 | 33 | 15 |
| 0.44 | Delis | 4 | 11 | 10 | 14 | 6 |
| 0.42 | Bakeries | 1 | 12 | 6 | 9 | 5 |
| 0.42 | Basque Restaurants | 1 | 1 | 5 | 4 | 1 |
| 0.41 | Chicken Wings | 4 | 6 | 7 | 9 | 3 |
| 0.40 | Barbeque Restaurants | 5 | 15 | 20 | 17 | 10 |
| 0.40 | Day Spas | 4 | 5 | 6 | 7 | 3 |
| 0.40 | Caribbean Restaurants | 1 | 5 | 6 | 5 | 3 |
| 0.39 | Buffets | 3 | 5 | 6 | 7 | 2 |
| 0.39 | Grocery | 2 | 10 | 13 | 7 | 9 |
| 0.38 | Cinema | 5 | 7 | 19 | 14 | 5 |
| 0.36 | Golf Courses | 2 | 2 | 3 | 1 | 3 |
| 0.36 | Resorts | 1 | 2 | 4 | 1 | 3 |
| 0.36 | Books, Maps, Music & | 1 | 4 | 4 | 4 | 1 |
| | Video | | | | | |

TABLE 3
Negative Sentiment

| loud | | 1- | 2- | 3- | 4- | 5- |
|---|---|---|---|---|---|---|
| 4,5/1-5 | CATEGORY | Star | Star | Star | Star | Star |
| 0.37 | Hotels | 35 | 42 | 61 | 51 | 18 |
| 0.37 | Event Planning & Services | 41 | 48 | 66 | 63 | 20 |
| 0.38 | Venues & Event Spaces | 6 | 10 | 14 | 11 | 1 |
| 0.39 | Hotels & Travel | 41 | 48 | 65 | 56 | 18 |
| 0.40 | Shopping Centers | 3 | 5 | 7 | 4 | 1 |
| 0.42 | Cuban Restaurants | 0 | 5 | 3 | 2 | 2 |
| 0.43 | Vietnamese Restaurants | 5 | 4 | 5 | 7 | 0 |
| 0.47 | Dance Clubs | 8 | 14 | 14 | 5 | 6 |
| 0.53 | Vegan Restaurants | 2 | 6 | 1 | 2 | 4 |
| 0.64 | Caterers | 2 | 5 | 0 | 4 | 0 |
| 0.71 | Home Services | 26 | 11 | 7 | 4 | 4 |
| 0.73 | Real Estate | 24 | 11 | 7 | 4 | 2 |
| 0.73 | Apartments | 24 | 11 | 7 | 4 | 2 |
| 0.76 | Fashion | 5 | 8 | 1 | 2 | 1 |

By computing both usage and polarity context for the entire sentiment vocabulary across all categories, a statistical “heatmap” can be generated showing the relative contextuality of all of the terms, from positive sentiment, to neutral sentiment, to negative sentiment, as shown below in Table 4:

TABLE 4
Heat Map

| | | 1- | 2- | 3- | 4- | 5- |
|---|---|---|---|---|---|---|
| Term # | Term | Star | Star | Star | Star | Star |
| 1 | invaluable | | | | 0.483 | 0.517 |
| 2 | welcomes | | | | 0.289 | 0.711 |
| 3 | rejuvenated | | | | 0.349 | 0.651 |
| 4 | invigorating | | | | 0.362 | 0.638 |
| 5 | outshines | | | | 0.442 | 0.558 |
| 1277 | delicious | 0.010 | 0.032 | 0.096 | 0.437 | 0.426 |
| 5132 | cheap | 0.067 | 0.111 | 0.193 | 0.380 | 0.248 |
| 10678 | loud | 0.086 | 0.150 | 0.229 | 0.372 | 0.163 |
| 11127 | predictable | 0.068 | 0.079 | 0.302 | 0.405 | 0.147 |
| 18031 | refund | 0.754 | 0.107 | 0.074 | 0.033 | 0.031 |
| 18086 | trashiest | 0.571 | 0.429 | | | |
| 18087 | counterproductive | 0.333 | 0.667 | | | |
| 18088 | disdainful | 0.750 | 0.250 | | | |
| 18089 | confusedly | 0.583 | 0.417 | | | |
| 18090 | discourteous | 0.600 | 0.400 | | | |

Finally, in the Table 5 below, usage and polarity context scores for each term across all categories that were computed from the three-level hashmap representation used to store the sparse sentiment score matrix are then output into a form directly usable by the run-time engine (e.g., the sentiment analysis application 116 in the examples). The table shows the contextualized sentiment score for the term “loud” across all categories that contained more than twenty reviews per category. The PN Score is the value provided back to the caller application used to override a −1, 0, or +1 sentiment polarity provided by the default (non-contextual) sentiment vocabulary. The category name on the right column indicates which context that the score of a particular term is relevant to. In implementation, the client application (e.g., the sentiment analysis application) can provide one or more category context terms to locate this term/score entry, as described above.

TABLE 5

| | nRe- | 1- | 2- | 3- | 4- | 5- | |
|---|---|---|---|---|---|---|---|
| PNScore | view | star | star | star | star | star | Category |
| 0.85 | 34 | 0 | 1 | 4 | 20 | 9 | British Pubs |
| 0.78 | 143 | 2 | 9 | 20 | 67 | 45 | Breweries |
| 0.77 | 26 | 0 | 1 | 5 | 13 | 7 | Art Galleries |
| 0.73 | 22 | 0 | 3 | 3 | 10 | 6 | Gastropubs |
| 0.71 | 156 | 8 | 9 | 29 | 75 | 35 | Wine Bars |
| 0.69 | 49 | 2 | 8 | 5 | 23 | 11 | Latin American |
| 0.67 | 72 | 4 | 6 | 14 | 30 | 18 | Active Life |
| 0.65 | 194 | 2 | 27 | 39 | 91 | 35 | Pubs |
| 0.64 | 187 | 13 | 21 | 33 | 72 | 48 | Coffee & Tea |
| 0.64 | 47 | 3 | 3 | 11 | 23 | 7 | Thai |
| 0.64 | 124 | 9 | 8 | 28 | 49 | 30 | Music Venues |
| 0.64 | 33 | 4 | 2 | 6 | 16 | 5 | Tex-Mex |
| 0.64 | 513 | 24 | 63 | 100 | 200 | 126 | Food |
| 0.63 | 111 | 8 | 20 | 13 | 45 | 25 | Mediterranean |
| 0.63 | 243 | 15 | 27 | 49 | 104 | 48 | Lounges |
| 0.62 | 87 | 2 | 17 | 14 | 33 | 21 | Vegetarian |
| 0.62 | 21 | 1 | 5 | 2 | 9 | 4 | Diners |
| 0.61 | 23 | 2 | 3 | 4 | 8 | 6 | Tapas/Small |
| | | | | | | | Plates |
| 0.61 | 56 | 8 | 3 | 11 | 19 | 15 | Dive Bars |
| 0.60 | 20 | 1 | 4 | 3 | 8 | 4 | Southern |
| 0.59 | 22 | 0 | 2 | 7 | 9 | 4 | Fitness & |
| | | | | | | | Instruction |
| 0.58 | 72 | 7 | 12 | 11 | 31 | 11 | Asian Fusion |
| 0.58 | 903 | 55 | 119 | 208 | 361 | 160 | American (New) |
| 0.57 | 180 | 16 | 21 | 40 | 74 | 29 | Sandwiches |
| 0.57 | 21 | 1 | 3 | 5 | 8 | 4 | Stadiums & |
| | | | | | | | Arenas |
| 0.57 | 1196 | 86 | 160 | 274 | 492 | 184 | Bars |
| 0.56 | 1301 | 97 | 175 | 295 | 533 | 201 | Nightlife |
| 0.56 | 239 | 14 | 35 | 56 | 85 | 49 | Italian |
| 0.56 | 25 | 3 | 2 | 6 | 6 | 8 | Ice Cream & |
| | | | | | | | Frozen Yogurt |
| 0.56 | 220 | 17 | 21 | 59 | 79 | 44 | Arts & |
| | | | | | | | Entertainment |
| 0.56 | 117 | 6 | 18 | 28 | 35 | 30 | Seafood |
| 0.55 | 38 | 1 | 4 | 12 | 14 | 7 | French |
| 0.55 | 250 | 14 | 42 | 57 | 98 | 39 | Pizza |
| 0.54 | 192 | 21 | 29 | 38 | 83 | 21 | Burgers |
| 0.53 | 30 | 3 | 4 | 7 | 15 | 1 | Karaoke |
| 0.53 | 3581 | 284 | 555 | 836 | 1344 | 562 | Restaurants |
| 0.53 | 51 | 6 | 9 | 9 | 13 | 14 | Beauty & Spas |
| 0.52 | 227 | 18 | 41 | 49 | 86 | 33 | Breakfast & |
| | | | | | | | Brunch |
| 0.52 | 27 | 3 | 1 | 9 | 12 | 2 | Indian |
| 0.50 | 319 | 28 | 56 | 75 | 120 | 40 | Mexican |
| 0.50 | 499 | 54 | 70 | 126 | 188 | 61 | American |
| | | | | | | | (Traditional) |
| 0.49 | 227 | 16 | 38 | 61 | 66 | 46 | Steakhouses |
| 0.48 | 60 | 2 | 10 | 19 | 24 | 5 | Irish |
| 0.47 | 72 | 7 | 11 | 20 | 14 | 20 | Chinese |
| 0.47 | 204 | 20 | 34 | 54 | 83 | 13 | Sports Bars |
| 0.46 | 261 | 29 | 45 | 66 | 98 | 23 | Japanese |
| 0.46 | 26 | 1 | 5 | 8 | 6 | 6 | Beer, Wine & |
| | | | | | | | Spirits |
| 0.46 | 363 | 39 | 57 | 100 | 134 | 33 | Sushi Bars |
| 0.45 | 106 | 12 | 26 | 20 | 33 | 15 | Shopping |
| 0.44 | 45 | 4 | 11 | 10 | 14 | 6 | Delis |
| 0.42 | 33 | 1 | 12 | 6 | 9 | 5 | Bakeries |
| 0.41 | 22 | 3 | 5 | 5 | 7 | 2 | Buffets |
| 0.40 | 67 | 5 | 15 | 20 | 17 | 10 | Barbeque |
| 0.40 | 25 | 4 | 5 | 6 | 7 | 3 | Day Spas |
| 0.40 | 20 | 1 | 5 | 6 | 5 | 3 | Caribbean |
| 0.39 | 41 | 2 | 10 | 13 | 7 | 9 | Grocery |
| 0.38 | 50 | 5 | 7 | 19 | 14 | 5 | Cinema |
| −0.37 | 206 | 35 | 42 | 61 | 50 | 18 | Hotels |
| −0.38 | 237 | 41 | 48 | 66 | 62 | 20 | Event Planning & |
| | | | | | | | Services |
| −0.38 | 42 | 6 | 10 | 14 | 11 | 1 | Venues & Event |
| | | | | | | | Spaces |
| −0.39 | 227 | 41 | 48 | 65 | 55 | 18 | Hotels & Travel |
| −0.40 | 20 | 3 | 5 | 7 | 4 | 1 | Shopping Centers |
| −0.43 | 21 | 5 | 4 | 5 | 7 | 0 | Vietnamese |
| −0.47 | 47 | 8 | 14 | 14 | 5 | 6 | Dance Clubs |
| −0.71 | 52 | 26 | 11 | 7 | 4 | 4 | Home Services |
| −0.73 | 48 | 24 | 11 | 7 | 4 | 2 | Real Estate |
| −0.73 | 48 | 24 | 11 | 7 | 4 | 2 | Apartments |

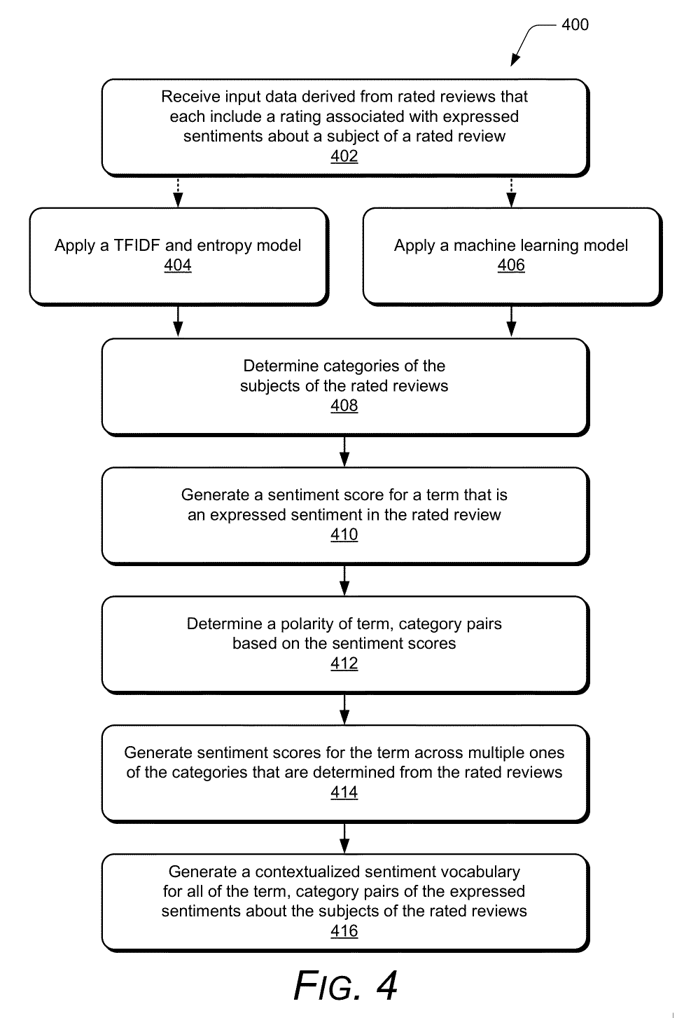

FIG. 4 illustrates example method(s) 400 of contextualized sentiment text analysis vocabulary generation, and is generally described with reference to a contextual analysis application implemented by a computing device. The order in which the method is described is not intended to be construed as a limitation, and any number or combination of the method operations can be combined in any order to implement a method, or an alternate method.

At 402, input data is received, where the input data is derived from rated reviews that each include a rating associated with expressed sentiments about a subject of a rated review. For example, the contextual analysis application 104 (FIG. 3) that is implemented by the computing device 102 (or implemented at a cloud-based data service as described with reference to FIG. 8) receives the input data 106 that is derived from rated reviews that each include a rating associated with expressed sentiments about a subject of a rated review.

At 404, a TFIDF and entropy model is applied to implement the techniques of contextualized sentiment text analysis vocabulary generation (as described at 408-414). Alternatively, at 406, a machine learning model is applied implement the techniques of contextualized sentiment text analysis vocabulary generation (as described at 408-414).

At 408, categories of the subjects of the rated reviews are determined and, at 410, a sentiment score for a term that is an expressed sentiment in the rated review is generated. For example, the TFIDF and entropy model 110, or the machine learning model 114, as implemented by the contextual analysis application 104 determines the subject categories 118 of the subjects of the rated reviews and generates the sentiment scores 120 for the terms 122 that are an expressed sentiment in a rated review. The sentiment score 120 for a term is generated based at least in part on a context of the term as the term pertains to the category and the rating of the rated review. In the TFIDF and entropy model, the terms that are expressed as the sentiments in the rated reviews can be ranked according to variance in the polarity of the terms across the multiple categories based on the sentiment scores that are each computed as a weighted entropy score for each term.

At 412, a polarity of the term-category pairs is determined based on the sentiment scores. For example, the TFIDF and entropy model 110, or the machine learning model 114, as implemented by the contextual analysis application 104 determines the polarity of the term-category pairs 124 based on the sentiment scores.

At 414, sentiment scores are generated for the term across multiple ones of the categories that are determined from the rated reviews. For example, the TFIDF and entropy model 110, or the machine learning model 114, as implemented by the contextual analysis application 104 generates the sentiment scores 120 for a sentiment term 122 across multiple ones of the subject categories 118 that are determined from the rated reviews, and the sentiment scores each indicate a degree to which the term is positive or negative for an associated category.

At 416, a contextualized sentiment vocabulary is generated for all of the term-category pairs of the expressed sentiments about the subjects of the rated reviews. For example, the contextual analysis application 104 generates one or more of the contextualized sentiment vocabularies 108 for all of the term-category pairs 124 of the expressed sentiments about the subjects of the rated reviews.

FIG. 5 illustrates an example 500 of the contextual analysis application 104 that is implemented by the computing device 102 as described with reference to FIG. 1, and that implements embodiments of contextualized sentiment text analysis vocabulary generation in an implementation of the term classification model 112. The contextual analysis application 104 includes various modules that implement features of the contextual analysis application for the term classification model, such as may be implemented as a logistic regression model. Although shown and described as independent modules of the contextual analysis application, any one or combination of the various modules may be implemented together or independently in the contextual analysis application in embodiments of contextualized sentiment text analysis vocabulary generation.

In this example, the contextual analysis application 104 includes a part-of-speech tagger module 502 that is implemented to receive the input data 106, such as the rated reviews as described with reference to FIG. 1. The part-of-speech tagger module 502 is a document, paragraph, and sentence segmenter, tokenizer, and a part-of-speech tagger using optimized lexical and contextual rules for grammar transformation, and generates a segmented and tokenized word punctuation list for each sentence of the input data. The part-of-speech tagger module 502 also implements a high accuracy method for part-of-speech tagging the first term of sentiment sentences. This is a challenging problem due to the capitalization of a first term in a sentence, which makes it difficult for conventional part-of-speech taggers to differentiate between proper nouns, regular nouns, and adjectives.

In an implementation, the part-of-speech (POS) tagger module 502 can include the better characteristics of multiple part-of-speech tagger systems, which significantly improves the overall first word part-of-speech tagging accuracy. For example, the part-of-speech tagger module 502 can combine features of the Adobe Research Sedona Brill tagger, the open-source NLTK POS tagger, and the Stanford POS tagger. The output differences from each of the different part-of-speech taggers can be evaluated for correctness, and a set of heuristic rules created to generalize detection of error patterns when outputs are not in agreement. The correction heuristic can then be applied to the capitalized words in question. The part-of-speech tagger module 502 may also be implemented to employ an ensemble of diverse part-of-speech taggers and generate correction rules in real-time based on a voting outcome.

In embodiments, the word classification model 112 is scalable, rapid, and can utilize stochastic gradient descent. The word classification model 112 is implemented to receive the part-of-speech data that includes the noun expressions, verb expressions, and tagged parts-of-speech of the input data. In application of a machine learning framework, the sentiment analysis is treated as a text classification problem, where a model is trained to determine which set of classes need to be assigned to text. The text to be classified can be represented as a vector of numeric features values derived from words (also referred to as terms), phrases, or other properties of the documents. For the purposes of subsequent procedural description (without loss of generality), each document is represented as a vector of term frequencies. More specifically, classifiers of the form y=f(x) are trained using a set of training examples D={(Xₙ, (Xₙ, Yₙ), . . . , (Xₙ, Yₙ)}, where the vector x_{i,1}=[(x_{i,1}, . . . , x_{i,j}, . . . x_{i,d}] is a set of normalized term frequencies from documents using the well-established TFIDF procedure. The y values are liking ratings for each piece of text as provided by a user providing the review.

An instantiation of the machine learning framework above is described below in terms of logistic regression, and any classifier in machine learning (Support Vector Machines, Neural Networks, Naïve Bayes Classifiers, and others) can be used to implement the term classification model. Each of these classifiers provide a slightly different estimate of contextuality and sentiment score for each concept, entity, or term. In an implementation, all of the machine learning classifiers can be used in an ensemble and run on the data, and the results are combined to generate one overall result.

Considering logistic regression, a conditional probability model of the form:

$$p ( y = + 1 \vert β , {x}_{i} ) = ψ ( {B}^{T} {x}_{i} ) = ψ ( {\sum }_{j} {β}_{j} {x}_{ij} )$$

where a particular link function, such as the logistic link function, is used. An estimate of the probability p that an example x=<x₁, . . . , x_{d}> is positive in the log-odds form:

$$log \frac{p}{1 - p} = α + {\sum }_{j = 1 … d}^{ } {B}_{j} {x}_{j}$$

thereby producing a logistic regression model. This can be simplified to:

$$p = \frac{exp ( {β}^{T} x )}{1 + exp ( {β}^{T} x )} .$$

The log of the conditional likelihood for a positive example is:

$$\frac{\partial }{\partial {β}_{j}} LCL ( x , y ) = \frac{1}{p} \frac{\partial }{\partial {β}_{j}} p$$

and for a negative example is:

$$\frac{\partial }{\partial {β}_{j}} LCL ( x , y ) = \frac{1}{1 - p} ( - \frac{\partial }{\partial {β}_{j}} p )$$

and it can be derived that:

$$\frac{\partial }{\partial {β}_{j}} LCL ( x , y ) = ( y - p ) {x}_{j}$$

which suggests that an update to the betas that would improve most LCL would be along the gradient. For a small step size lambda, this would mean that:

Bⱼ=Bⱼ+λ(y−p)xᵢ

which leads to a very fast algorithm.

For many of the models, and in particular logistic regression, to make accurate predictions for future inputs, over-fitting should be avoided in implementations, where the learning system over-weights the idiosyncrasies of the training data to an extent that the model and the accompanying insight is no longer generalizable to other datasets. Typically, the Bayesian approach to logistic regression model is to impose a univariate Gaussian prior with mean 0 and a variance >0 on each parameter. Laplace Priors and Lasso Logistic Regression can also be used in a similar fashion to avoid over-fitting. Generally, in the case of logistic regression, no inexpensive computational procedures for finding the posterior mean exists, hence posterior mode estimation is used to estimate the parameters of the model. These parameters ultimately indicate the degree to which a particular term and its frequency in the document contributes to the sentiment score of the document. If it is the case that these parameters vary across categories, that term is highly contextual (e.g., the “predictable” example is negative for movies but positive for consumer devices).

The contextual analysis application 104 and models are also implemented to take into account the use synonyms or antonyms to describe the same context. For instance, a particular user might use the term “large” whereas another might use the term “big”. Similarly, one user might use the term “fearful” whereas another might use “afraid” to describe a particular emotional state. Where possible, these terms are grouped together to for contextuality attribution at the right level of granularity in the calculations. Additionally, conjunctives are often used in sentiment expressions. For instance, conjunctives such as “but” are usually followed by a sentiment that is opposite of what appears before them. Other terms that have this property are “however”, “nevertheless”, “even though”, “with the exception of”, “in spite of”, and others. Similarly, “negation” rules such as “not” reverse the sentiment of a particular opinion term. Hence “not angry” has the opposite sentiment of “angry”.

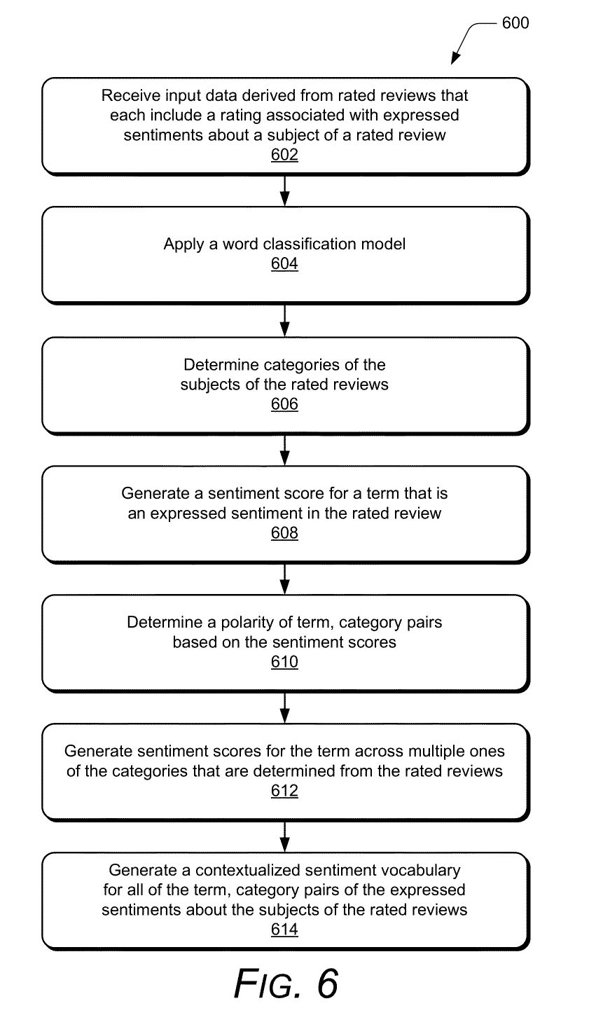

FIG. 6 illustrates example method(s) 600 of contextualized sentiment text analysis vocabulary generation, and is generally described with reference to a contextual analysis application implemented by a computing device. The order in which the method is described is not intended to be construed as a limitation, and any number or combination of the method operations can be combined in any order to implement a method, or an alternate method.

At 602, input data is received, the input data derived from rated reviews that each include a rating associated with expressed sentiments about a subject of a rated review. For example, the contextual analysis application 104 (FIG. 3) that is implemented by the computing device 102 (or implemented at a cloud-based data service as described with reference to FIG. 8) receives the input data 106 that is derived from rated reviews that each include a rating associated with expressed sentiments about a subject of a rated review.

At 604, a word classification model is applied to implement the techniques of contextualized sentiment text analysis vocabulary generation (as described at 606-612). For example, the word classification model can be implemented by the contextual analysis application 104 for logistic regression, support vector machines, neural networks, Bayesian classification, and other word classification techniques.

At 606, categories of the subjects of the rated reviews are determined and, at 608, a sentiment score for a term that is an expressed sentiment in the rated review is generated. For example, the word classification model 112 as implemented by the contextual analysis application 104 determines the subject categories 118 of the subjects of the rated reviews and generates the sentiment scores 120 for the terms 122 that are an expressed sentiment in a rated review. The sentiment score 120 for a term is generated based at least in part on a context of the term as the term pertains to the category and the rating of the rated review.

At 610, a polarity of the term-category pairs is determined based on the sentiment scores. For example, the word classification model 112 as implemented by the contextual analysis application 104 determines the polarity of the term-category pairs 124 based on the sentiment scores. At 612, sentiment scores are generated for the term across multiple ones of the categories that are determined from the rated reviews. For example, the word classification model 112 as implemented by the contextual analysis application 104 generates the sentiment scores 120 for a sentiment term 122 across multiple ones of the subject categories 118 that are determined from the rated reviews, and the sentiment scores each indicate a degree to which the term is positive or negative for an associated category.

At 614, a contextualized sentiment vocabulary is generated for all of the term-category pairs of the expressed sentiments about the subjects of the rated reviews. For example, the contextual analysis application 104 generates one or more of the contextualized sentiment vocabularies 108 for all of the term-category pairs 124 of the expressed sentiments about the subjects of the rated reviews.

FIG. 7 illustrates an example 700 of the sentiment analysis application 116 that is implemented by the computing device 102 as described with reference to FIG. 1, and that implements embodiments of contextualized sentiment text analysis vocabulary generation. The sentiment analysis application 116 includes various modules that implement features of the sentiment analysis application. Although shown and described as independent modules of the sentiment analysis application, any one or combination of the various modules may be implemented together or independently in the sentiment analysis application in embodiments of contextualized sentiment text analysis vocabulary generation.

The sentiment analysis application 116 includes a word type tagging module 702 that is implemented to receive the input data 106 as the part-of-speech information that includes noun expressions, verb expressions, and tagged parts-of-speech of one or more sentences. The input data 106 can include sentences that express positive, neutral, and negative sentiments, as well as suggestions and/or recommendations about a subject of a sentence. The word type tagging module 702 is implemented to identify and tag noun, verb, adjective and adverb sentence fragment expressions, as well as tag and group parts-of-speech of the sentences. The word type tagging module 702 provides a two-level sentence tagging structure for subsequent sentiment annotation. Terms within each fragment or phrase are first tagged with their part-of-speech (e.g., as a noun, verb, adjective, adverb, determiner, etc.), and then lexical expression types for each grouping of the terms and part-of-speech tags are assigned. The lexical expression types include noun expressions, verb expressions, and adjective expressions, and the word type tagging module 702 generates a two-level sentence expression and part-of-speech tag structure for each sentence, which is output at 704. The output structure identifies the elements of a sentence, such as where the noun expressions are most likely to occur in the sentence, and the adjective expressions that describe the elements in the sentence.

The sentiment analysis application 116 also includes a sentiment terms tagging module 706 that is implemented to determine adjective forms of the adjective expressions utilizing a sentiment vocabulary dictionary database 708 to identify meaningful sentence phrases. The sentiment analysis application 116 receives the part-of-speech annotated source terms and computes the sentiment polarity, intensity, and context for each submitted adjective, adverb, and noun term. The sentiment terms tagging module 706 can utilize the sentiment category vocabulary database 708, such as a default non-contextualized sentiment vocabulary that is constant across categories, or a domain specific contextualized sentiment vocabulary for selected categories, given one or more category context terms. The sentiment terms tagging module 706 can tag and annotate each sentiment term in the two-level tag structure, and generate an annotated data structure, which is output at 710.

The sentiment analysis application 116 also includes a sentiment topic model module 712 that receives the annotated data structure and is implemented to identify and extract the key topic noun expressions from each sentence. In implementations, the sentiment topic model module 712 also accepts as input a sentiment neutral topic model, such as from the natural language contextual analysis application 104, and generates a weighted topic model indicating fine-grain sentiment for specific terms and/or lexical terms, such as the noun expressions and adjective expressions. The sentiment topic model module 712 tags the noun terms of a sentence that is processed as the input data 106 as topics of the sentence based on the noun expressions, and associates each of the topics with the sentiment about the subject of the sentence. The determined topics of the input sentence text data are output as a noun expressions topic model from the sentiment topic model module at 714.

The sentiment analysis application 116 also includes a sentence phrase sentiment scoring module 716 that is implemented to aggregate the sentiment about the subject for each of the one or more topics of the sentence to score each of the noun expressions as represented by one of the topics of the sentence. The sentence phrase sentiment scoring module 716 computes the overall emotion and sentiment polarity and score for each topic model noun expression and sentence based on the earlier sentiment annotations and scores for each expression (or fragment) using individual term sentiment term scores and counts. The sentence and phrase-level sentiment scoring is performed to assign a positive or negative value score to each specific phrase within a sentence based on the presence of affect and sentiment keywords in that phrase. Phrase-level sentiment and affect scores are then summed to yield a sentence level score normalized by the total number of adjectives, adverbs, and nouns in the sentence. Sentences may have a zero score in the event that no sentiment or affect keywords are detected. The noun expression topic models are also retained at this stage for use by the sentiment metadata output module.

The sentiment analysis application 116 also includes a positive, negative, and suggestion verbatim scoring and extraction module 718 that is implemented to determine and extract the highest scoring positive and negative sentiment sentences, as well as actionable suggestion and/or recommendation sentences, and collect them into separate lists to indicate the most important positive, negative, and suggestion verbatims. The important (e.g., high scoring) positive, negative, and suggestion sentences are identified and extracted by the extraction module 718 by ranking the sentences based on score and by detection of actionable terms and keywords. The extraction module 718 can be implemented with heuristics that use natural language and statistics to determine the most important positive and negative verbatims, as well as the recommendations and/or suggestions. The separate lists of the most important positive, negative, and suggestion verbatims can then be accessed at the output 720 by the sentiment metadata output module 722.

The sentiment analysis application 116 also includes a session summary level sentiment scoring module 724 that is implemented to collect and count the positive and negative sentiment and affect contribution for all of the terms, and computes an aggregate affect and sentiment score. The sentence level sentiment score information and annotated terms from the sentence phrase sentiment scoring module 716 are input at 726 to the session summary level sentiment scoring module 724, which determines session or collection level sentiment scoring by computing a weighted average of all sentence sentiment scores. The sentiment scoring module 724 can be implemented to provide a measure of the net sentiment expressed in a group of sentences that typically represent a conversation or collection of feedback comments. The sentence-level and session-level sentiment and affect annotations, sentiment score metadata, part-of-speech statistics, and optional verbatim statements are forwarded to the sentiment metadata output module 722 at the output 720.

The sentiment metadata output module 722 can then generate a formatted output from the sentiment analysis application 116. For example, the output module can organize the examples of the customer comments “I love this software application”, “I would recommend this application to others”, “Your software is too expensive”, and “Add some text edit features to the application” that are input as the input data 106. The generated output can indicate verbatim positive remarks, such as “I love this software application” and “I would recommend this application to others”. The generated output can also include verbatim negative remarks, such as “Your software is too expensive”, as well as verbatim suggestions or recommendations, such as “Add some text edit features to the application”.

FIG. 8 illustrates an example system 800 in which embodiments of contextualized sentiment text analysis vocabulary generation can be implemented. The example system 800 includes a cloud-based data service 802 that a user can access via a computing device 804, such as any type of computer, mobile phone, tablet device, and/or other type of computing device. The computing device 804 can be implemented with a browser application 806 through which a user can access the data service 802 and initiate a display of an application interface 808, such as a user interface of the contextual analysis application 104, which may be displayed on a display device 810 that is connected to the computing device. The computing device 804 can be implemented with various components, such as a processing system and memory, and with any number and combination of differing components as further described with reference to the example device shown in FIG. 9.

In embodiments of contextualized sentiment text analysis vocabulary generation, the cloud-based data service 802 is an example of a network service that provides an on-line, Web-based version of the contextual analysis application 104 that a user can log into from the computing device 804 and display the application interface 808. The network service may be utilized by any client, such as marketers and product and/or service providers, to generate analysis outputs and reports to determine topics that customers are discussing or communicating, as well as the related sentiments, emotions, and opinions that are being expressed by customers in their communications. The data service can also maintain and/or upload the input data 106 that is input to the contextual analysis application 104.

Any of the devices, data servers, and networked services described herein can communicate via a network 812, which can be implemented to include a wired and/or a wireless network. The network can also be implemented using any type of network topology and/or communication protocol, and can be represented or otherwise implemented as a combination of two or more networks, to include IP-based networks and/or the Internet. The network may also include mobile operator networks that are managed by a mobile network operator and/or other network operators, such as a communication service provider, mobile phone provider, and/or Internet service provider.

The cloud-based data service 802 includes data servers 814 that may be implemented as any suitable memory, memory device, or electronic data storage for network-based data storage, and the data servers communicate data to computing devices via the network 812. The data servers 814 maintain a database 816 of the input data 106, as well as the contextualized sentiment vocabulary 108 that is generated by the contextual analysis application 104.

The cloud-based data service 802 includes the contextual analysis application 104, such as a software application (e.g., executable instructions) that is executable with a processing system to implement embodiments of contextualized sentiment text analysis vocabulary generation. The contextual analysis application 104 can be stored on a computer-readable storage memory, such as any suitable memory, storage device, or electronic data storage implemented by the data servers 814. Further, the data service 802 can include any server devices and applications, and can be implemented with various components, such as a processing system and memory, as well as with any number and combination of differing components as further described with reference to the example device shown in FIG. 9.

The data service 802 communicates the contextualized sentiment vocabulary 108 and the application interface 808 of the contextual analysis application 104 to the computing device 804 where the application interface is displayed, such as through the browser application 806 and displayed on the display device 810 of the computing device. The contextual analysis application 104 can also receive user inputs 816 to the application interface 808, such as when a user at the computing device 804 initiates a user input with a computer input device or as a touch input on a touchscreen of the device. The computing device 804 communicates the user inputs 816 to the data service 802 via the network 812, where the contextual analysis application 104 receives the user inputs.

FIG. 9 illustrates an example system 900 that includes an example device 902, which can implement embodiments of contextualized sentiment text analysis vocabulary generation. The example device 902 can be implemented as any of the devices and/or server devices described with reference to the previous FIGS. 1-8, such as any type of client device, mobile phone, tablet, computing, communication, entertainment, gaming, media playback, digital camera, and/or other type of device. For example, the computing device 102 shown in FIG. 1, as well as the computing device 804 and the data service 802 (and any devices and data servers of the data service) shown in FIG. 8 may be implemented as the example device 902.

The device 902 includes communication devices 904 that enable wired and/or wireless communication of device data 906, such as user images and other associated image data. The device data can include any type of audio, video, and/or image data, as well as the images and denoised images. The communication devices 904 can also include transceivers for cellular phone communication and/or for network data communication.

The device 902 also includes input/output (I/O) interfaces 908, such as data network interfaces that provide connection and/or communication links between the device, data networks, and other devices. The I/O interfaces can be used to couple the device to any type of components, peripherals, and/or accessory devices, such as a digital camera device 910 and/or display device that may be integrated with the device 902. The I/O interfaces also include data input ports via which any type of data, media content, and/or inputs can be received, such as user inputs to the device, as well as any type of audio, video, and/or image data received from any content and/or data source.

The device 902 includes a processing system 912 that may be implemented at least partially in hardware, such as with any type of microprocessors, controllers, and the like that process executable instructions. The processing system can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The device 902 may further include any type of a system bus or other data and command transfer system that couples the various components within the device. A system bus can include any one or combination of different bus structures and architectures, as well as control and data lines.

The device 902 also includes computer-readable storage media 914, such as storage memory and data storage devices that can be accessed by a computing device, and that provide persistent storage of data and executable instructions (e.g., software applications, programs, functions, and the like). Examples of computer-readable storage media include volatile memory and non-volatile memory, fixed and removable media devices, and any suitable memory device or electronic data storage that maintains data for computing device access. The computer-readable storage media can include various implementations of random access memory (RAM), read-only memory (ROM), flash memory, and other types of storage media in various memory device configurations.

The computer-readable storage media 914 provides storage of the device data 906 and various device applications 916, such as an operating system that is maintained as a software application with the computer-readable storage media and executed by the processing system 912. In this example, the device applications also include a contextual analysis application 918 that implements embodiments of contextualized sentiment text analysis vocabulary generation, such as when the example device 902 is implemented as the computing device 102 shown in FIG. 1 or the data service 802 shown in FIG. 8. An example of the contextual analysis application 918 includes the contextual analysis application 104 implemented by the computing device 102 and/or at the data service 802, as described in the previous FIGS. 1-8.

The device 902 also includes an audio and/or video system 920 that generates audio data for an audio device 922 and/or generates display data for a display device 924. The audio device and/or the display device include any devices that process, display, and/or otherwise render audio, video, display, and/or image data, such as the image content of a digital photo. In implementations, the audio device and/or the display device are integrated components of the example device 902. Alternatively, the audio device and/or the display device are external, peripheral components to the example device.

In embodiments, at least part of the techniques described for contextualized sentiment text analysis vocabulary generation may be implemented in a distributed system, such as over a “cloud” 926 in a platform 928. The cloud 926 includes and/or is representative of the platform 928 for services 930 and/or resources 932. For example, the services 930 may include the data service 802 as described with reference to FIG. 8. Additionally, the resources 932 may include the contextual analysis application 104 that is implemented at the data service as described with reference to FIG. 8.

The platform 928 abstracts underlying functionality of hardware, such as server devices (e.g., included in the services 930) and/or software resources (e.g., included as the resources 932), and connects the example device 902 with other devices, servers, etc. The resources 932 may also include applications and/or data that can be utilized while computer processing is executed on servers that are remote from the example device 902. Additionally, the services 930 and/or the resources 932 may facilitate subscriber network services, such as over the Internet, a cellular network, or Wi-Fi network. The platform 928 may also serve to abstract and scale resources to service a demand for the resources 932 that are implemented via the platform, such as in an interconnected device embodiment with functionality distributed throughout the system 900. For example, the functionality may be implemented in part at the example device 902 as well as via the platform 928 that abstracts the functionality of the cloud 926.

Although embodiments of contextualized sentiment text analysis vocabulary generation have been described in language specific to features and/or methods, the appended claims are not necessarily limited to the specific features or methods described. Rather, the specific features and methods are disclosed as example implementations of contextualized sentiment text analysis vocabulary generation.

1. A method, comprising:
receiving input data derived from rated reviews that each include a rating associated with expressed sentiments about a subject of a rated review;
determining categories of the subjects of the rated reviews;
generating a sentiment score for a term that is an expressed sentiment in the rated review, the sentiment score generated based at least in part on a context of the term as the term pertains to the category and the rating of the rated review; and
determining a polarity of a term-category pair based on the sentiment score.

2. The method as recited in claim 1, further comprising:
generating additional sentiment scores for the term across multiple ones of the categories that are said determined from the rated reviews, the additional sentiment scores each indicating a degree to which the term is positive or negative for an associated category.

3. The method as recited in claim 2, further comprising:
generating a contextualized sentiment vocabulary for all of the term-category pairs of the expressed sentiments about the subjects of the rated reviews.

4. The method as recited in claim 2, further comprising:
applying a machine learning model that implements said determining the categories, generating the sentiment scores for the term across the multiple categories, and determining the polarity of the term-category pairs based on the sentiment scores.

5. The method as recited in claim 2, further comprising:
applying a term frequency inverse document frequency (TFIDF) and entropy model that implements said determining the categories, generating the sentiment scores for the term across the multiple categories, and determining the polarity of the term-category pairs based on the sentiment scores.

6. The method as recited in claim 5, further comprising:
ranking all of the terms that are expressed as the sentiments according to variance in the polarity of the terms across the multiple categories based on the sentiment scores that are each computed as a weighted entropy score for each term.

7. The method as recited in claim 2, further comprising:
applying a term classification model that implements said determining the categories, generating the sentiment scores for the term across the multiple categories, and determining the polarity of the term-category pairs based on the sentiment scores.

8. The method as recited in claim 7, wherein the term classification model is implemented as a logistic regression model that determines conditional probabilities of the term being positive or negative across the multiple categories.

9. A computing device, comprising:
a memory configured to maintain input data that is derived from communications about subjects, each of the communications including a rating that is associated with expressed sentiments about a subject of the communication;
a processor system to implement a contextual analysis application that is configured to:
determine categories of the subjects of the communications;
generate a sentiment score for a term that is an expressed sentiment in a communication, the sentiment score generated based at least in part on a context of the term as the term pertains to the category and the rating of the communication; and
determine a polarity of a term-category pair based on the sentiment score.

10. The computing device as recited in claim 9, wherein the contextual analysis application is configured to generate additional sentiment scores for the term across multiple ones of the categories that are determined from the communications, the additional sentiment scores each indicating a degree to which the term is positive or negative for an associated category.

11. The computing device as recited in claim 10, wherein the contextual analysis application is configured to generate a contextualized sentiment vocabulary for all of the term-category pairs of the expressed sentiments about the subjects of the communications.

12. The computing device as recited in claim 10, wherein the contextual analysis application is configured to apply a machine learning model that is implemented to said determine the categories, generate the sentiment scores for the term across the multiple categories, and determine the polarity of the term-category pairs based on the sentiment scores.

13. The computing device as recited in claim 10, wherein the contextual analysis application is configured to apply a term frequency inverse document frequency (TFIDF) and entropy model that is implemented to said determine the categories, generate the sentiment scores for the term across the multiple categories, and determine the polarity of the term-category pairs based on the sentiment scores.

14. The computing device as recited in claim 13, wherein the contextual analysis application is configured to rank all of the terms that are expressed as the sentiments according to variance in the polarity of the terms across the multiple categories based on the sentiment scores that are each computed as a weighted entropy score for each term.

15. The computing device as recited in claim 10, wherein the contextual analysis application is configured to apply a term classification model that is implemented to said determine the categories, generate the sentiment scores for the term across the multiple categories, and determine the polarity of the term-category pairs based on the sentiment scores.

16. The computing device as recited in claim 15, wherein the term classification model is implemented as a logistic regression model that determines conditional probabilities of the term being positive or negative across the multiple categories.

17. A computer-readable storage memory comprising a contextual analysis application stored as instructions that are executable and, responsive to execution of the instructions by a computing device, the computing device performs operations of the contextual analysis application comprising to:
receive input data derived from rated reviews that each include a rating associated with expressed sentiments about a subject of a rated review;
determine categories of the subjects of the rated reviews;
generate a sentiment score for a term that is an expressed sentiment in the rated review, the sentiment score generated based at least in part on a context of the term as the term pertains to the category and the rating of the rated review;
determine a polarity of a term-category pair based on the sentiment score; and
generate a contextualized sentiment vocabulary for all of the term-category pairs of the expressed sentiments about the subjects of the rated reviews.

18. The computer-readable storage memory as recited in claim 17, wherein the computing device performs operations of the contextual analysis application further comprising to generate additional sentiment scores for the term across multiple ones of the categories that are determined from the rated reviews, the additional sentiment scores each indicating a degree to which the term is positive or negative for an associated category.

19. The computer-readable storage memory as recited in claim 17, wherein the computing device performs operations of the contextual analysis application further comprising to apply a term frequency inverse document frequency (TFIDF) and entropy model that is implemented to said determine the categories, generate the sentiment scores for the term across the multiple categories, and determine the polarity of the term-category pairs based on the sentiment scores.

20. The computer-readable storage memory as recited in claim 17, wherein the computing device performs operations of the contextual analysis application further comprising to apply a logistic regression model that is implemented to said determine the categories, generate the sentiment scores for the term across the multiple categories, and determine the polarity of the term-category pairs based on the sentiment scores.
